(19) United States
(12) Patent Application Publication
(10) Pub. No.: US 2010/0129258 A1
(43) Pub. Date: May 27, 2010

(54) FUNCTIONALIZATION OF A SUBSTRATE SYSTEM AND METHOD

(75) Inventors: César Diez Gil, Barcelona (ES); Imma Ratera Bastardas, St Cugat Del Vallés (ES); Jaume Veciana Miró, Barcelona (ES); Rosario Martinez, Murcia (ES); Faboiola Zapata, Murcia (ES); Antonio Caballero, Murcia (ES); Alberto Tárraga, Murcia (ES); Pedro Molina, Murcia (ES)

Correspondence Address: IP Patent Docketing;K&L GATES LLP, 599 Lexington Avenue, 33rd Floor, New York, NY, 10022-6030, US

(73) Assignees: CONSEJO SUPERIOR DE INVESTIGACIONES CIENTIFICAS; UNIVERSIDAD DE MURCIA

(21) Appl. No.: 12/521,471

(22) PCT Filed: Dec. 5, 2007
(86) PCT No.: PCT/ES2007/070206

§ 371 Date: Oct. 26, 2009

(30) Foreign Application Priority Data
Dec. 27, 2006 (ES) P200603285

(51) Int. Cl. G01N 21/77; B05D 1/38; B01J 20/32

(52) U.S. Cl. 422/57; 427/202; 977/902

(57) ABSTRACT

Disclosed herein are embodiment relating to a methods of obtaining a functionalized porous or fibrous solid substrate with the chemical and/or physical properties of a nano-structured molecular or polymer chemical compound that contains it. In accordance with some example embodiments, the properties of the starting substrate may be modified to obtain a new functionalized substrate. The new substrate may have various applications, such as, for example, an optical- and/or fluorescent-type chemical sensor, as a chemical sequestrator, or as a modifier of the properties of a surface, making it, for example, superhydrophobic.

### CROSS-REFERENCES TO RELATED APPLICATIONS

This application claims the benefit under 35 U.S.C. §371 to PCT/ES2007/070206 filed Dec. 5, 2007, which claims the benefit of Patent Application P200603285 filed Dec. 27, 2006 in Spain. The entire disclosures of said applications are incorporated herein by reference thereto.

### BACKGROUND

Substrates may be coated in order to modify their properties for a given application. It is appreciated that there are a variety of methods related to the improvement and modification of the properties of substrates by modifying the surface thereof. Various techniques that make it possible to deposit substances on the surface of a substrate:

Surface modification by physical vapour deposition (PVD) is on example technique. PVD generally consists of a coating process by evaporation, wherein a material is transferred atom by atom from the solid to the gas phase, and again to the solid phase, thereby gradually building a film on the substance that is to be coated. This technique may produce hard, resistant coatings, and is a suitable technique for inorganic coatings. If applicable, this method may be used to coat hard-to-access substrate areas, which would otherwise be very difficult to reach. There are variants of the PVD technique, including: “ion plating”, “ion beam” and “arc discharge evaporation”. Using this technique, it is very difficult to treat organic substances, whether substrates or coatings

Another technique is chemical vapour deposition (CVD). In this process, the substrate must be placed inside a reactor, where a number of gases are introduced that chemically react with one another, leading to a new solid compound that will be deposited on the substrate. The coatings obtained are highly homogeneous, but, as in the previous case, the applications are limited due to the high temperatures required. (although in this case they are much lower than those used in PVD). Therefore, this method does not allow organic coatings and/or treatment of substrates of this type.

Electrodeposition is another technique used to coat surfaces. As the name implies, it is based on the use of an electrical current for the deposition of electro-active substances on the surface to be treated. Its use is therefore restricted to conductive materials and is applicable to obtain electrodes. This technique may be used for organic coatings provided that said compound conducts current. Two practical examples are International Publication Number WO 2006/023933 and WO 2006/028482, which disclose two different methods for the generation of coatings using electrodeposition-based techniques.

Another method used to generate coatings for solid substrates is thermal oxidation. This method is limited to materials that may be oxidised and the oxide meets the desired characteristics (for example, passivation, electric insulation). The basis of the method is oxidation of the surface of the substrate to be treated. It is therefore essential that said modification grants the material the desired surface properties. This method is only useful for inorganic compounds and the needs high temperatures. One of the most versatile techniques for the coating of surfaces is casting. This technique consists of depositing a solution of the substance intended to be used as coating on the substrate to be coated, either by means of a spray or by rotating the sample, such that a very homogeneous layer is formed. Once the solvent is evaporated, the coating is obtained. This is particularly useful for polymers and is particularly useful in the production of next-generation materials or materials related to the technology industry, such as silicon derivatives. International Publication Number WO 2003/078145 shows an example of the versatility of this coating technique, since in this case the coated surface are contact lenses, which are made of a very sensitive material that may not be coated by any of the above-mentioned techniques.

There are other ways to modify surface properties, such as, for example, the incorporation of functional groups on the surface by co-polymerisation, as disclosed in the article Eur. Polym. J., 2006, 42, 1487, by authors L. N. Pilon, S. P. Armes, P. Findlay and S. P. Rannard, to obtain, for example, superhydrophobic cellulose surfaces.

The use of various techniques for the creation of materials with special properties is widely spread in the industry today; however, they have limited capacities. Despite the fact that many industries are attempting to overcome said limitations, there are also many others, such as the semiconductor industry, the biomaterials industry, new technologies, etc., that are committed to the development of a new concept of materials creation based on new technologies, such as nanotechnology.

One example of the use of nanoparticles to coat substrates is found in patent International Publication Number WO 2003/106573 A1, which generally discloses a method of coating substrates from transparent conductive nano-powder, to produce transparent, conductive nano-coatings. In addition to the nanoparticles, this method requires the use of additives, polymers or surfactants, which makes the coating process longer and more costly.

### BRIEF DESCRIPTION OF THE DRAWINGS

For the purpose of complementing this description and helping to better understand the example embodiments disclosed herein, a set of drawings in accordance with some particular example embodiments has been included as an integral part of this specification, wherein the following have been represented in an illustrative and non-limiting manner:

FIG. 1 shows a photograph of a functionalized mixed cellulose ester membrane with a functional organic compound according to one example embodiment.

FIGS. 2a) and 2b) show two images of functionalized membranes with different quantities of nanoparticles of the functional molecular compound in accordance with some example embodiments.

FIG. 3 shows the change in luminescence of a membrane after filtrating 10 ml of a solution with different concentrations of mercury ions according to one example embodiment.

FIG. 4 shows the change in luminescence of a membrane coated with a functional molecular compound (composite) after filtering a solution with different concentrations of mercury ions according to the example embodiment.

FIG. 5 shows the intensity curve with respect to the size of an aqueous suspension of nanoparticles obtained by the Dynamic Light Scattering (DLS) technique according to one example embodiment.

FIG. 6 shows an SEM image of the nanoparticles' plate-form morphology according to one example embodiment.

### BRIEF DESCRIPTION OF EXAMPLE EMBODIMENTS

There have been no techniques available that makes it possible to functionalize substrates with certain characteristics, such as, for example, porous or fibrous substrates, in a simple, effective manner and at a low cost. Some example embodiments relates to a method of obtaining a functionalized porous or fibrous solid substrate with the chemical and/or physical properties of a nano-structured molecular or polymer chemical compound that contains it. With the method of some example embodiments, the properties of the starting substrate may be modified to obtain a new functionalized substrate.

The new substrate thus obtained may have various applications, such as, for example, an optical- and/or fluorescent-type chemical sensor, as a chemical sequestrator, or as a modifier of the properties of a surface, making it, for example, superhydrophobic.

In some example embodiments, a chemical sensor may be obtained which may be used in sensor devices with the capacity for the selective detection of substances such as, for example, metallic ions or other ionic species present in an aqueous medium.

A first aspect of an example embodiment provides a method for the functionalization of a substrate from a molecular or polymer compound, where said substrate is an organic or inorganic porous membrane, insoluble in an aqueous medium, and where said molecular compound is a functional compound, insoluble in an aqueous medium and soluble in an organic compound miscible in water.

The method of some example embodiments does not require the use of relatively complex procedures for anchoring the molecular compound on solid surfaces, such as those described by Langmuir-Bloddget, or the use of external matrices, such as cross-linked polymers. In accordance with a first aspect of an example embodiment, the method ensures the preservation of the properties that the molecular compound had in solution, directly functionalizing the substrate thereon and without performing any chemical or physical modification of the participating substances.

Also, in accordance with the first aspect of an example embodiment, a method is provided for the functionalization of substrates that requires only relatively small quantities of the molecular compound, which may constitute an economical method.

Moreover, in accordance with the first aspect of an example embodiment, the substrate may be as simple as a cellulose membrane, which is economical, biodegradable and renewable. Cellulose membranes have very good mechanical properties and are water absorbers.

In accordance with the first aspect of an example embodiment, a method is provided which comprises:

i) preparing an aqueous suspension of nanoparticles of a functional molecular compound, where the size of the nanoparticles is equal to or smaller than the pore size of the substrate (porous membrane) and, subsequently,

ii) filtrating said aqueous suspension obtained in step i) through the substrate that is to be functionalized, such that said nanoparticles of the molecular compound coalesce on said substrate, the compound and the substrate remaining intimately bound.

A second aspect of an example embodiment is to provide a functionalized substrate, where said molecular compound and said substrate are intimately bound after performing the method in accordance with the first aspect of an example embodiment, which may be used as a sensor.

In accordance with the second aspect of an example embodiment, the functionalized substrate, also called composite, has applications for the selective detection of different substances, such as, for example, the detection of metallic ions or other ionic species, such as, for example, phosphates of biological interest present in an aqueous medium.

A third aspect of an example embodiment is to provide a functionalized substrate obtained in accordance with the first aspect of the example embodiment which may be used as a sequestrator agent.

A fourth aspect of an example embodiment is to provide a device that comprises a functionalized substrate in accordance with the first aspect of the example embodiment.

In some example embodiments, a technique is provided that makes it possible to functionalize substrates with certain characteristics with nanoparticulate molecular or polymer compounds that have functional properties, such that said functional properties are incorporated into the substrate and, therefore, a new functionalized substrate, also called composite, is obtained.

In accordance with some example embodiments, it is possible to provide an easy-to-apply, profitable technique that does not make any chemical or physical modifications of the substrate or the molecular compound, and uses only relatively small quantities of the functional molecular compound.

In accordance with some example embodiments, “molecular compound of interest or functional molecular compound” is understood to be any molecular compound which, due to its physical-chemical characteristics, has functional properties, is insoluble in an aqueous medium but soluble in an organic solvent miscible in water.

Organic solvents miscible in water include tetrahydrofuran, acetonitrile, ethanol, or mixtures thereof, although other organic solvents are also included within the scope of the various embodiments.

The molecular compounds of interest or functional molecular compounds may have particular physical-chemical properties, such as, for example, hydrophobicity, or opto-electronic or magnetic or chemical properties that make them useful as sensors, in particular, as optical- and/or fluorescent-type chemical sensors or sequestrators of ionic or molecular species.

In accordance with some example embodiments, “substrate” is any organic or inorganic porous membrane that is insoluble in an aqueous medium. Optionally, said organic or inorganic porous membrane is made of fibres.

Substrates may include natural or artificial organic-polymer-based membranes, which may be formed by cross-linked fibres, such as, for example, cellulose, nylon or polycarbonate.

In accordance with some example embodiments, a method is provided for the functionalization of porous or fibrous substrates starting from a functional molecular compound.

In particular, various embodiments comprise obtaining coatings of porous membranes starting from aqueous suspensions of nanoparticles of functional molecular compounds. Said suspensions are filtered through the porous substrate that is to be functionalized, and said membrane has a pore size of the same order of magnitude or greater than the size of the nanoparticles of the molecular compound in suspension.

During the filtration, the nanoparticles in suspension may coalesce along the membrane pores or, if applicable, the membrane fibres, thereby obtaining a perfect coating of the walls of the porous membrane, while maintaining its porous capacity and, therefore, making it possible to subsequently filter aqueous solutions without any difficulty in order to selectively detect or sequester certain chemical substances.

In accordance with the substrate functionalization technique of example embodiments, it is not necessary to evaporate the sample (cases of PVD and CVD) or to apply a current (electrodeposition). Moreover, it is relatively environmental-friendly technique, since the suspensions of nanoparticles are aqueous and, consequently, there is no waste from organic solvents in the process, which was not as obvious in the case of casting (where the entire process is performed in solution and the solvent has to be evaporated, with the consequent environmental problem, in addition to the economic cost of managing said waste).

In accordance with example embodiments, the substrate functionalization technique disclosed herein does not need special instruments, since the technique may be implemented with only a vacuum pump and a stirrer. Moreover, in various embodiments, it is also not necessary to use an additive or a fixing polymer.

The type of substrates (porous membranes) and coatings (molecular or polymer compounds) used in some example embodiments are not suitable for the existing methods, due to the low volatility or the low resistance to temperature of the substrates or their non-conductive nature.

In turn, the coating obtained presents very good homogeneity and durability, since, upon filtering the suspension of nanoparticles, the latter melt, forming a new layer on the surface. In one embodiment, said layer is cross-linked with the fibres that make up the membrane, leaving the membrane pores open for subsequent filtrations. Consequently, the surface area of the molecular compound of interest or functional molecular compound may be relatively large, thereby increasing the sensitivity toward other stimuli of a device that contains it for the application thereof (such as, for example, metallic ions or other ionic species, such as, for example, phosphates of biological interest).

After this coating, the functional organic compound is retained inside the membrane pores in the above-mentioned manner, and may not be easily eliminated. Due to its simplicity, the economic cost of said technique is very low and, therefore, it has high commercial interest.

In particular, the preparation of said aqueous suspension of nanoparticles, in accordance with example embodiments, comprises:

i) dissolving said functional molecular compound in an organic solvent miscible in water until a solution of at least 10^{-x} M is obtained, where x is between −1 and −5;

i) pouring at least 1 μl of said solution i) in the form of drops on thermostatised water under stirring, such that the functional molecular compound precipitates and, consequently, the suspension of nanoparticles is formed.

The size of the nanoparticles may be controlled by the thermostatization and control of the stirring of the water whereto the drops of organic solution of our functional molecular compound are added. In some example embodiments, the ideal size of the nanoparticles may be of the same order of magnitude or slightly smaller than the pore size of the membrane that is to be coated; to this end, the temperature of the solution may be modified between 0° C. and 100° C., with a rate of stirring greater than 500 rpm, and in some embodiments, between 2,000 and 5,000 rpm.

The suspension of nanoparticles obtained from the functional molecular compound is filtered through the organic or inorganic porous membrane that is to be functionalized. Said filtration may be a gravity or overpressure filtration, for example, or a filtration assisted by a vacuum-generation medium, water jet or vacuum pump, etc., with a filtration flow rate between 5 and 100 ml/min.

Therefore, in accordance with the first aspect of various embodiments of the method, a firm coating of a functional molecular compound will be formed on a porous membrane by a process of filtration of a suspension of nanoparticles, thereby obtaining a thin layer of the functional molecular compound not only on the surface of the substrate, but also to a given depth thereof.

During the filtration of the suspension of nanoparticles, a small penetration thereof takes place toward the interior of the membrane and, subsequently, the nanoparticles melt, forming a new layer on the surface which, in turn, is cross-linked with the fibres that form the membrane, leaving the membrane pores open for subsequent filtrations. Consequently, the functional molecular compound may have a maximum surface area, thereby increasing the sensitivity toward other stimuli of a device containing it for the application thereof (response to metallic ions or other ionic species, such as, for example, phosphates of biological interest).

Coating of the membrane takes place not only on the most superficial part of the membrane, but, due to the size of the filtered nanoparticles (less that or equal to the membrane pore size), the material may homogeneously penetrate through the pores a few hundreds of nanometres (between 100 and 1,000 nm), thereby providing the coating with a high degree of firmness and homogeneity.

In some example embodiments, the membrane is prepared without any type of additives, such as coating polymers or modifiers that assist in fixing compounds on surfaces.

Moreover, in some example embodiments, even scratching the membrane with a finger or immersing the membrane in water, the coating may not be easily eliminated from the membrane, which is indicative of the firmness of the coating.

On the other hand, the load or concentration of the nanoparticles may depend on the number of ml of suspension of nanoparticles filtered through the membrane, in one embodiment, the minimum load being 10 ml of suspension of nanoparticles. Thus, the membrane's sensitivity toward external stimuli may be modified for the application thereof.

Therefore, in accordance with the first aspect of an example embodiment, the filtered nanoparticles may go through the membrane pores, which are slightly smaller, and, subsequently, agglomerate, forming said coating of the fibres or pores. Therefore, once the nanoparticles are filtered, the molecular compound and the selected substrate may be intimately bound, due to the penetration and consequent cross-linking of the nanoparticles with the fibres or pores that compose the substrate and themselves.

Due to the size ratio between the nanoparticles and the membrane pores, the nanoparticles are firmly captured in the membrane. In one embodiment, over 99% of the nanoparticles are retained in the membrane, which makes it possible to control, in a very reliable manner, the concentration of the functional compound retained on the surface of the membrane.

In various embodiments, there may be a maximum load of functional molecular compound whereafter the coating of the membrane is excessive, which would entail full closing of the pores and, therefore, would not allow for its use as a membrane. The maximum coating may depend on the size of the pores and the size of the nanoparticles used.

In some example embodiments, the penetration of the functional molecular compound through the membrane is less than 1 μm.

After performing the technique in accordance with the first aspect of an example embodiment, a hybrid material (composite) is obtained, which may be composed of a porous membrane with the walls of the pores coated with a functional compound on the most superficial part.

Another object of an example embodiments is the use of said hybrid material or functionalized substrate in accordance with the technique disclosed herein as a sensor or sequestrator agent, as well as for the selective detection and signalling of a chemical substance.

Depending on the physical-chemical properties of the functional molecular compound, specialised membranes for specific uses may be prepared depending on the final application requirements, such as, for example, in the field of sensors of metallic ions or other ionic species, such as, for example, phosphates of biological interest.

In accordance with one example embodiment, a method is provided for obtaining a specific sensor, the composite (hybrid material) generated that is explained in more detail below, and which has the characteristics of a sensor for mercury in water.

A sensor is understood to be a device that is capable of detecting manifestations of physical qualities or phenomena and, in turn, signalling this detection by providing physical, chemical or biological information about our environment.

### Example 1

### Manufacturing of Analytical Test Strips from Organic Sensor Compounds for the Detection of ppb of Mercury in Aqueous Media

An actual application of an example embodiment is described that is designed to obtain a selective sensor membrane for mercury ions, where the molecular compound of interest, X, used for the coating is 1-pyren-4-p-methoxyphenyl-2,3-diaza-1,3-butadiene and the porous membrane, Y, is a mixed cellulose ester.

Compound of Interest:

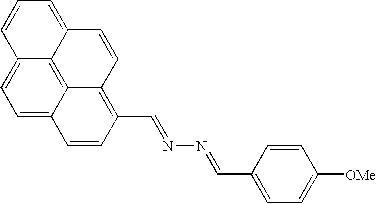

For the selective detection of mercury ions, said functional organic compound may be any derivative with aza bridges or similar, and with sensory, colorimetric or luminescent properties.

A 10⁻³ M (3.62 mg) solution of 1-pyren-4-p-methoxyphenyl-2,3-diaza-1,3-butadiene (X) is prepared. (Compound X selectively recognises mercury ions, forming a very stable mercury (II) complex, which leads to the increase in luminescence. This molecule has been synthesised in accordance with J. Am. Chem. Soc. 2005, 127, 15666.) 100 μl of said solution are added, drop by drop with a microsyringe, to 10 ml of ultra-pure water at ambient temperature under strong stirring (≧4,000 rpm). This instantaneously generates said suspension of nanoparticles of the sensor molecule for mercury ions.

This procedure leads to nanoparticles of the organic compound described above, 100 nm in size and relatively monodisperse.

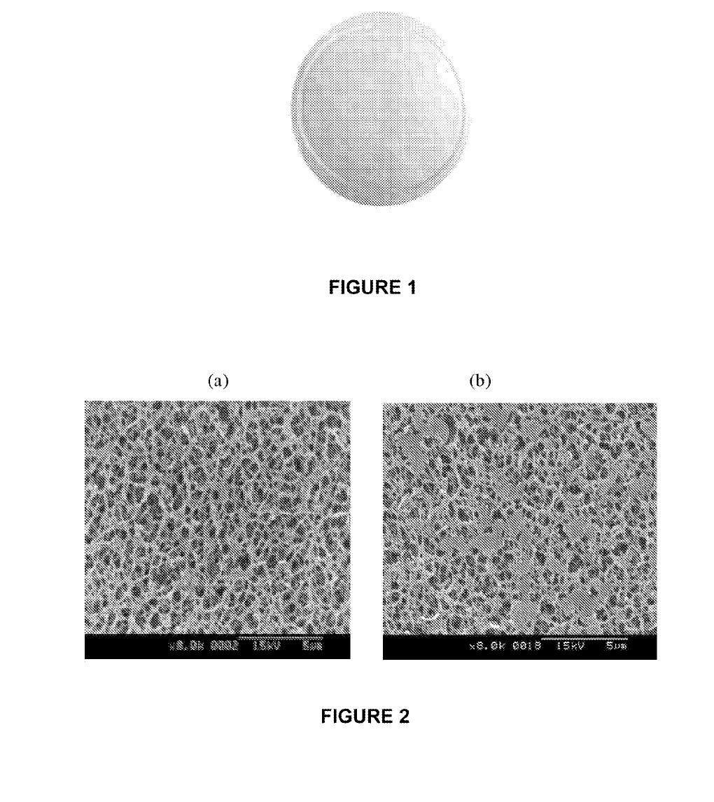

Subsequently, the suspension may be filtered through a mixed cellulose ester membrane (Advantech, 0.1 micrometres in pore size and 47 millimetres in diameter) by means of a vacuum filtration assembly, for example, with a flow rate of 35 ml/min. The method of preparing the 10 ml of suspension and the filtration thereof may be repeated 3 times, in order to obtain optimal coating of the membrane, as well as optimal operation of the membrane as a sensor for mercury ions in water. As a result, a composite (hybrid material: organic membrane—functional organic compound) may be obtained that is highly homogeneous, as observed in FIG. 1.

With reference to FIG. 1, it may be observed that the colour intensity throughout the membrane is constant, which indicates a high degree of uniformity of dispersion of the functional molecular compound on the surface of the membrane.

Once aqueous solutions with different concentrations of [Hg(ClO₄)₂] (from 10⁻⁸ M to 10⁻³M) have been prepared, they may be filtered through the previously prepared sensor membranes (one membrane for each mercury solution, for example), using the same vacuum system and the same flow rate used to manufacture the sensor membranes, for example.

Once the aqueous solutions with different concentrations of mercury ions have been filtered through the sensor membranes, their luminescence is measured, which provides an indication of the recognition of mercury ions.

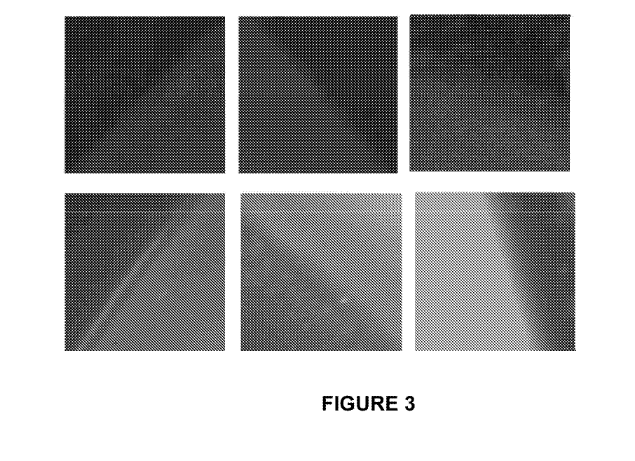

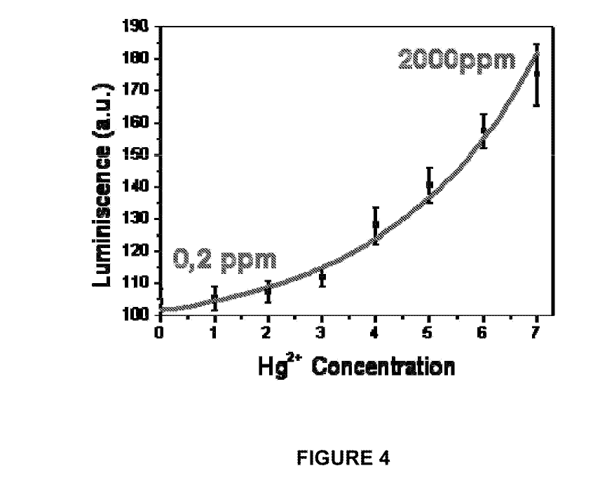

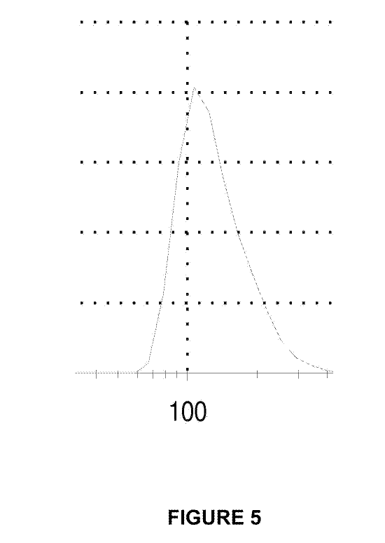

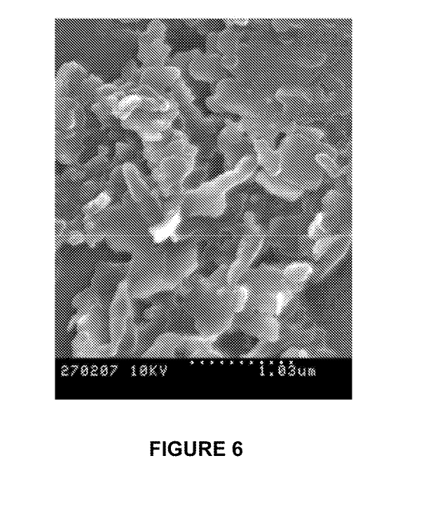

The luminescence measurements are performed with a LEICA luminescence magnifying glass associated with a digital camera. In this way, digital images of the luminescence are obtained for each membrane (see FIG. 3), which, once treated with a software, allow quantification of the luminescence intensity in each of the membranes tested and, consequently, the ratio between the concentration of mercury present in the aqueous solution to be analysed and the luminescence of the membrane (see FIG. 4). The detection limit calculated for the reagent in FIG. 4 was in the range of ppb. This example shows the good coating of the membrane with the functional organic compound following the methodology of various embodiments, as well as the good behaviour of the mercury sensor obtained, which may detect very small concentrations of mercury ions present in water (in the range of ppb).

With reference to FIG. 3, the change in luminescence of a membrane after filtrating 10 ml of a solution with different concentrations of mercury ions is shown: a) ligand only, b) 10⁻⁶ M, c) 10⁻⁵ M, d) 10⁻⁴ M, e) 10⁻³ M, f) 10⁻² M (from top to bottom and from left to right).

FIGS. 2a) and 2b) show two images of functionalized membranes with different quantities of nanoparticles of the functional molecular compound in accordance with some example embodiments. FIG. 2a) shows a coating of the mixed cellulose ester membrane from the filtration of 5 ml of a suspension of nanoparticles of a compound of interest 100 nm in diameter. FIG. 2b) shows a coating of the mixed cellulose ester membrane from the filtration of 20 ml of a suspension of nanoparticles of a compound of interest 100 nm in diameter. These images were obtained by scanning electron microscopy (SEM) following a process of metallization of the membrane with a thin layer of gold in order to obtain a sample that was additionally conductive.

For higher concentrations of mercury, these membranes may also be used as simple “dip test strips”. In this case, the concentration of mercury may be determined by immersing the test strips coated with the sensor molecule in accordance with various embodiments in aqueous solutions of mercury ions, from the strip fluorescence measurement. Moreover, these test strips are permeable to water and, for this reason, water samples with only traces of metals may be enriched on the surface of the membrane by simple filtration, such that very low detection limits for mercury ions may be achieved.

The solution of the molecular sensor may be unnoticeable for both the “dip test strip” and the filtration process, due to the firm retention of the molecular sensor in the membrane's fibrous network.

Analytical test strips such as those described in the examples offer a relatively simple, convenient method for on-site analysis and daily water quality monitoring without the need to use relatively complex, expensive equipment.

In sum, a mixed cellulose ester membrane has been firmly coated with a functional organic compound without the need for any additional matrix with applicability thereof in the field of mercury sensors, for example.

According to some example embodiments, the method is relatively simple and applicable for a great variety of molecular compounds of interest, as well as for different types of membranes.

The coating of porous membranes with the method disclosed herein has allowed a much greater surface area for the sensor to be obtained and, therefore, to greatly increase the sensitivity of this system. Moreover, since these membranes are permeable to water, they allow detection concentrations of ionic species in the range of ppb.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a” and “an” and “the” and similar referents used in the context of the following claims are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

The use of the term “or” in the claims is used to mean “and/or” unless explicitly indicated to refer to alternatives only or the alternatives are mutually exclusive, although the disclosure supports a definition that refers to only alternatives and “and/or.”Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Of course, variations on those preferred embodiments will become apparent to those of ordinary skill in the art upon reading the foregoing description. The inventor expects those of ordinary skill in the art to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific example embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

Further, it is to be understood that the example embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described in the specification and drawings.

1-16. (canceled)

17. A method for the functionalization of a substrate, comprising:
providing a compound, wherein the compound is one of a molecular compound and a polymer compound, wherein the compound is a functional compound that is insoluble in an aqueous medium and soluble in an organic solvent miscible in water, wherein the substrate is one of an organic porous membrane and an inorganic porous membrane, and wherein the substrate is insoluble in an aqueous medium;
preparing an aqueous suspension of nanoparticles of the compound, wherein the size of the nanoparticles is equal to or smaller than a pore size of the substrate;
filtering the aqueous suspension through the functionalized substrate to coalesce the nanoparticles of the compound on the substrate; and
intimately bonding the compound and the substrate.

18. The method according to claim 17, wherein filtering the aqueous suspension comprises forming at least a partial coating of the pores of the substrate.

19. The method according to claim 18, wherein fibres of the pores of the substrate are at least partially coated.

20. The method according to claim 18, wherein a wall of the pores of the substrate are at least partially coated.

21. The method according to claim 18, wherein the partial coating is to a substrate depth of at least 100 nm.

22. The method according to claim 18, wherein preparing the aqueous suspension comprises:
dissolving the compound in an organic solvent miscible in water until a solution of at least 10^{-x} M is obtained; wherein x is between −1 and −5; and
pouring at least 1 μl of the solution in the form of drops on thermostatised water under stirring, wherein the compound precipitates and the suspension of nanoparticles forms.

23. The method according to claim 22, wherein the organic solvent is selected from the group consisting of tetrahydrofuran, acetonitrile, and ethanol, or a mixture thereof.

24. The method according to claim 22, wherein the size of the nanoparticles is controlled.

25. The method according to claim 22, wherein the temperature of water is between 0° C. and 100° C., and wherein the rate of stirring is at least 500 rpm.

26. The method according to claim 17, wherein filtering the aqueous suspension is performed by one of gravity, vacuum, and overpressure filtration.

27. The method according to claim 17, wherein filtering the aqueous suspension is performed at a filtration flow rate of between about 5 ml/min and 100 ml/min.

28. The method according to claim 17, wherein the substrate is selected from an material and an inorganic material, or a natural or synthetic polymer.

29. The method according to claim 17, wherein the substrate is selected from a natural polymer and a synthetic polymer.

30. The method according to claim 17, wherein the substrate is a structure of cross-linked fibres.

31. The method according to claim 30, wherein the substrate is selected from a group consisting of cellulose, nylon and polycarbonate.

32. The method according to claim 30, wherein the substrate has a pore size less than or equal to about 100 nm.

33. A functionalized substrate obtained in accordance with the method of claim 1, wherein the functionalized substrate is a sensor or a sequester agent.

34. The functionalized substrate of claim 33, wherein the substrate is configured to selectively detect and signal the presence of a chemical substance.

35. A device comprising the functionalized substrate produced by the method of claim 33.

36. A device of claim 35, wherein the device is a sensor.
